(19) United States
(12) Patent Application Publication
(10) Pub. No.: US 2009/0219898 A1
(43) Pub. Date: Sep. 3, 2009

(54) DEVICE AND METHOD FOR INCREASING THE ROBUSTNESS OR THE CAPACITY OF WIRELESS COMMUNICATION SYSTEMS

(76) Inventor: Marc Chenu-Tournier, Paris (FR)

Correspondence Address: LOWE HAUPTMAN & BERNER, LLP, 1700 DIAGONAL ROAD, SUITE 300, ALEXANDRIA, VA, 22314, US

(21) Appl. No.: 11/910,293

(22) PCT Filed: Mar. 31, 2006
(86) PCT No.: PCT/EP06/61255

§ 371 Date: Jun. 17, 2008

(30) Foreign Application Priority Data
Apr. 1, 2005 (FR) 05 03179

(51) Int. Cl. H04W 4/00

(52) U.S. Cl. 370/338

(57) ABSTRACT

The invention relates to a method for increasing the capacity of a wireless communications system comprising at least two users U₁ and U₂ communicating by means of at least one frequency band F₁, F₂ wherein the stream of information s₁(t) of the first user U₁ and the stream of information s₂(t) of the second user U₂ flow in at least one same frequency band.

### CROSS-REFERENCE TO RELATED APPLICATIONS

The present Application is based on International Application No. PCT/EP2006/061255, filed on Mar. 31, 2006, which in turn corresponds to French Application No. 0503179 filed on Apr. 1, 2005, and priority is hereby claimed under 35 USC §119 based on these applications. Each of these applications are hereby incorporated by reference in their entirety into the present application.

### FIELD OF THE INVENTION

The invention relates notably to a method and a device making it possible to increase the capacity of wireless telecommunication systems, notably by introducing diversity into a reception system.

### BACKGROUND OF THE INVENTION

In the description, diversity is understood to be the capacity to use several copies of one and the same signal sent. Each copy has undergone independent degradations or distortions (channel or interference).

### SUMMARY OF THE INVENTION

In propagation channels that undergo fading or interference, reception diversity makes it possible notably to greatly increase the performance of the receiver and therefore the robustness or the capacity of the telecommunications link.

To introduce diversity into the telecommunication link, the use of sensor networks at the receive end and/or at the transmit end is an effective means when processing operations tailored to transmission and/or reception are implemented.

One of the drawbacks of these procedures is that they require the use of several receive or transmit pathways.

A method known in the prior art described for example in the book by Proakis, Digital Communication, chapter 8, 4^{th} edition, Mc Graw-Hill, uses the frequency diversity or temporal diversity of the propagation channel by means of a “channel coding” system. The useful information is processed firstly to introduce redundancy. This coded information is thereafter transmitted through different propagation channels so as to introduce diversity into the decoder.

The invention relies notably on a new approach by simultaneously transmitting through several propagation channels, the superposition of the messages to be transmitted.

The invention relates to a method for increasing the capacity of a wireless communications system comprising at least two users U₁ and U₂ communicating by means of at least one frequency band F₁, F₂ characterized in that the stream of information s₁(t) of the first user U₁ and the stream of information s₂(t) of the second user U₂ flow in at least one same frequency band.

The method according to the invention makes it possible notably to enhance the performance of the demodulation in a system with respect to the conventional system, one band, one stream.

One of the benefits of the present invention is that it makes it possible to enhance the receiver with additional diversity as compared with the conventional case where each transmitter makes exclusive use of the frequency band which has been dedicated to it.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 a basic diagram of the method according to the invention,

FIG. 2 shows diagrammatically a device architecture making it possible to implement the invention,

FIG. 3 results of the performance obtained by implementing the invention.

### DETAILED DESCRIPTION OF THE INVENTION

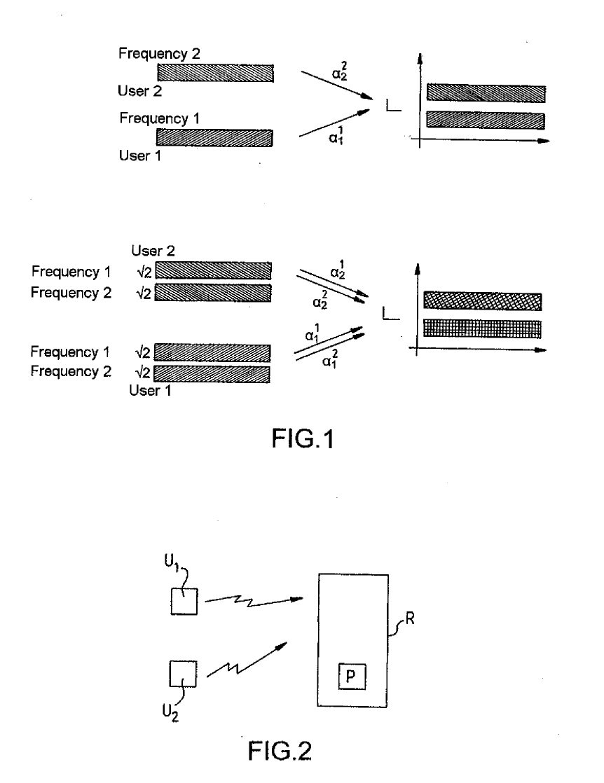

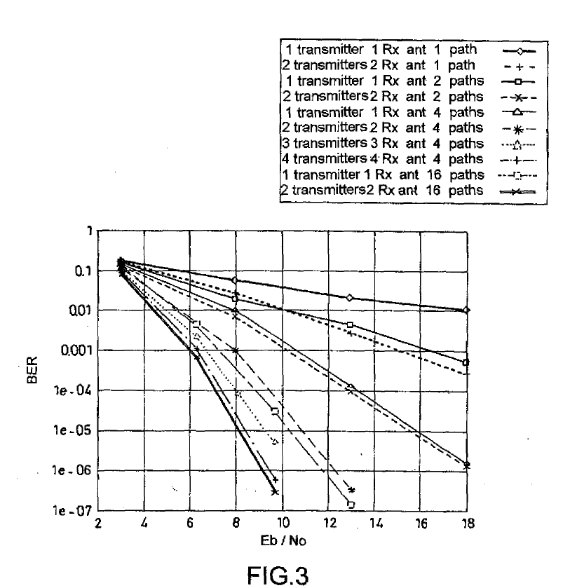

FIG. 1 shows diagrammatically the steps implemented in the case of a system using two frequencies. This can be extended to any system comprising a number greater than 2 of users and frequencies.

The system represented in FIG. 2 comprises several users Ui sending information streams across several frequency bands, a receiver R comprising notably a processor P suitable for implementing the steps of the method according to the invention.

The user U₁ transmits in a frequency band F₁ and the user U₂ in a frequency band F₂. The method consists notably in transmitting the streams s₁(t) and s₂(t) of each of the users on each of the frequency bands. Thus, on each frequency band the sum of the two informative streams or streams of interest originating from the two users propagates.

In the case of two users, in each band, a user transmits with a power that is halved, thereby helping to decrease the transmission power to avoid increasing the power transmitted in a cell.

By denoting s₁(t) the first stream and s₂(t) the second stream corresponding respectively to the users U₁ and U₂ and by considering that the disturbance introduced by the propagation channel is composed of Gaussian additive noise bᵤ(t) with 1≦u≦2 and of an attenuation a^{l}ᵥ, for example following a Rayleigh law, with the frequency i satisfying 1≦i≦2 and the index of the users u satisfying 1≦u≦2, the signals received by the receiver are expressed:

z₁(t)=a₁¹s₁(t)+a₂¹s₂(t)+b₁(t)

z₂(t)=a₁²s₁(t)+a₂²s₂(t)+b₂(t)

These observations can be written in the following matrix form:

$$z = [ \begin{matrix}{α}_{1}^{1} & {α}_{2}^{1} \\ {α}_{1}^{2} & {α}_{2}^{2}\end{matrix} ] [ \begin{matrix}{s}_{1} ( t ) \\ {s}_{2} ( t )\end{matrix} ] + [ \begin{matrix}{b}_{1} ( t ) \\ {b}_{2} ( t )\end{matrix} ]$$

On the basis of this signal model, the techniques of joint equalization and of detection that are known to the person skilled in the art can be applied to the observations to estimate the useful signals transmitted to an access point.

According to an embodiment, each transmitter sends with less power than that which it uses in the one band, one frequency case. One of the benefits of the method is to introduce what the person skilled in the art calls diversity into the receiver. In the case of transmission channels degraded by multipaths this diversity makes it possible to improve the performance of reception systems without consuming more band or raising the power.

The technical teaching set forth above applies in respect of an uplink from several users to an access point using several frequencies, or frequency division multiple access.

It also applies in the time domain, time division multiple access, or even with code division multiple access.

The method according to the invention also applies in respect of downlinks. For example when one wishes to transmit from an access point to several users, it is possible to introduce diversity into the receiver.

In the case where the system comprises three users referenced by their signals S₁, S₂, S₃ to whom one wishes to transmit information and three frequencies, on each frequency F₁, F₂ and F₃, a pair of signals (s₁,s₂) or (s₁,s₃) or (s₂,s₃) is transmitted.

In the simple case of a channel composed of Rayleigh fading and of additive noise, the observations utilizable by the receiver are:

z₁(t)=a₁(s₁(t)+s₂(t))+b₁(t)

z₂(t)=a₂(s₁(t)+s₃(t))+b₂(t)

z₃(t)=a₃(s₂(t)+s₃(t))+b₃(t)

With these observations, the method constructs the following signals, as first processing at the receiver level:

$$z ( t ) = \frac{{z}_{1} ( t )}{{α}_{1 }} + \frac{{z}_{2} ( t )}{{α}_{2 }} - \frac{{z}_{3} ( t )}{{α}_{3}} \\ = 2 \cdot {s}_{1} ( t ) + \frac{{b}_{1} ( t )}{{α}_{1 }} + \frac{{b}_{2} ( t )}{{α}_{2 }} - \frac{{b}_{3} ( t )}{{α}_{3}}$$

or else

$$z ( t ) = [ \begin{matrix}{α}_{1} & {α}_{1} & \\ {α}_{2} & & {α}_{2} \\ & {α}_{3} & {α}_{3}\end{matrix} ] [ \begin{matrix}{s}_{1} ( t ) \\ {s}_{2} ( t ) \\ {s}_{3} ( t )\end{matrix} ] + [ \begin{matrix}b ( t ) \\ {b}_{2} ( t ) \\ {b}_{3} ( t )\end{matrix} ]$$

It is thereafter possible to apply the joint detection techniques known to the person skilled in the art to these observations to determine or estimate the signals or the symbols which have been transmitted.

In the case of the downlink, by using the method with spread spectrum techniques, the demodulation can be simplified when the number of users simultaneously using the same frequency band is not too high. In this case, a receiver of RAKE type (filter matched to the channel and to the code) suffices and therefore, the use of two bands to introduce sufficient diversity.

Without departing from the scope of the invention, the method also applies to another type of access, by modulation.

In a downlink, rather than using a frequency or time slot to transmit streams to a user, it is possible to share a multilevel modulation between various users.

In the case of two users using a QPSK (Quadrature Phase Shift Keying) modulation, on one frequency, the stream which is dedicated thereto is transmitted on the real part for, for example, the even bits and the imaginary part are dedicated to another user.

Likewise on another frequency, one of the axes serves to transmit the odd bits of the first user and the other axis serves the second user.

According to a variant embodiment, in the case of an uplink, fewer channels than users are used. The choice of the channels to be used rests on their statistical independence.

In this case, it is possible by using the information arising from the decoder in combination with an iterative receiver to demodulate the various informative streams transmitted, according to a method known by the person skilled in the art. This can be the method described in the applicant's patent application FR 03/14014.

FIG. 2 represents curves of performance obtained by implementing the method according to the invention.

The simulation parameters used are:
The number of transmitters (# users),
The number of channels used (# Rx equal to the number of transmitters #Rx=#users),
The number of independent paths per propagation channel (#paths).

The latter parameter is interesting in the sense that the method utilizes the introduction of diversity to separate the various streams. It is noted that the gain of such a method is greater in the case where the order of diversity is low. Specifically, it is under these conditions that increasing the order of diversity has the most impact on performance.

In this example, the system utilizes an OFDM modulation (Orthogonal frequency-division multiplexing) with either a frequency-based or time-based multiple access system. Thus various transmitters can share this resource by communicating simultaneously with the constraint that the method for separating multiple streams is embedded in the reception system.

In this context, the method has been implemented for an OFDM modulation using 64 sub-carrier, of which only 52 are used to transmit data.

In this exemplary application, the system utilizes an OFDM modulation with either a frequency-based or time-based multiple access system. Thus, various transmitters can share this resource by communicating simultaneously with the constraint that the method for separating multiple streams is embedded in the reception system.

In this comparative study the performance of the method is simulated and compared with a method which does not use the principle of the invention case or the method is not implemented. This study focuses on the uplink and the technique for separating the various streams of the various users is a soft output maximum likelihood algorithm. The modulation used is a BSPK, the propagation channels are assumed to be known and independent between the users and the (temporal or frequency) resources. The parameters of the waveform employ those of the 802.11a standard including the corrector coding aspects. In the example given the total powers transmitted remain constant whatever the transmission method used so as to obtain relevant comparisons.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method for increasing the capacity of a wireless communications system comprising at least two users U₁ and U₂, the user U₁ transmits in a frequency band F₁, and the user U₂ transmits in a frequency band F₂, wherein the streams of s₁(t) and s₂(t) of each of the users flow on each of the frequency band.

2. The method as claimed in claim 1, wherein the signals received by the receiver are expressed:
z₁(t)=a₁¹s₁(t)+a₂¹s₂(t)+b₁(t)
z₂(t)=a₁²s₁(t)+a₂²s₂(t)+b₂(t)
where s₁(t) is the first stream corresponding to a first user U₁ and s₂(t) the second stream corresponding to a second user U₂ and the disturbance introduced by the propagation channel is composed of Gaussian additive noise bᵤ(t) with 1≦u≦2 and of an attenuation α_{υ}^{ι, with the frequency i satisfying} 1≦i≦2 and the index of the users u satisfying 1≦u≦2.

3.
z₁(t)=a₁¹s₁(t)+a₂¹s₂(t)+b₁(t)
z₂(t)=a₁²s₁(t)+a₂²s₂(t)+b₂(t)
The method as claimed in claim 1, wherein the communication is made from the users to an access point.

4. The method as claimed in claim 1, wherein the communication is made from an access point to several users.

5. The method as claimed in claim 1, wherein the transmission power is decreased for each user.

6. The method as claimed in claim 2, wherein the transmission power is decreased for each user.

7. The method as claimed in claim 1, wherein fewer transmission channels than users are used.

8. The method as claimed in claim 2, wherein fewer transmission channels than users are used.

9. The method as claimed in claim 3, wherein fewer transmission channels than users are used.
